(19) United States
(12) Patent Application Publication
(10) Pub. No.: US 2026/0202882 A1
(43) Pub. Date: Jul. 16, 2026

(54) FOLDING PORTABLE DISPLAY DEVICE WITH HOLD-CLOSED FORCE

(71) Applicant: Google LLC, Mountain View, CA (US)

(72) Inventors: Yongho Lim, Kildeer, IL (US); Tsung-Yuan Ou, New Taipei City (TW); Kuo-Wei Wu, New Taipei City (TW); Wen Shian Lin, New Taipei City (TW)

(21) Appl. No.: 19/443,405

(22) Filed: Jan. 8, 2026

Related U.S. Application Data
(60) Provisional application No. 63/745,995, filed on Jan. 16, 2025.

(51) Int. Cl. G06F 1/16

(52) U.S. Cl. CPC G06F 1/1679; G06F 1/1652; G06F 1/1681

(57) ABSTRACT

An example folding device includes a hinge assembly; a first assembly rotatably connected to the hinge assembly about a first axis; a second assembly rotatably connected to the hinge assembly about a second axis; and a continuous display spanning the hinge assembly and connected to the first assembly and the second assembly, wherein the hinge assembly comprises: a synchronization slider configured to synchronize movement of the first assembly and the second assembly, wherein, as the first assembly and the second assembly rotate, the synchronization slider translates along a direction parallel to the first axis and the second axis, and wherein the synchronization slider includes one or more projections perpendicular to the direction; and a latching track disposed within the hinge assembly and configured to interface with the one or more projections of the synchronization slider to provide a force to retain the folding device in a closed state.

This application claims the benefit of US Provisional Patent Application No. 63/745,995, filed 16 January 2025, the entire contents of which are incorporated herein by reference.

### BACKGROUND

Devices that include displays may be referred to as display devices. In general, it may be desirable to increase a size of a display (e.g., the area on which images are displayed) as much as possible. Increasing the size of a display may make the device that includes the display large and unwieldy. For instance, devices with larger displays may not fit in pockets, bags, and the like. One way to increase the size of a display without negatively affecting the portability of the device is to make the device collapsible such that the display can be folded (e.g., in half, thirds, etc.).

### SUMMARY

In general, aspects of this disclosure are directed to a hinge assembly of a folding device that provides a “hold closed” force to assemblies of the folding device. The assemblies of the folding device (e.g., “halves” or housings) may be moved in order to open and close the folding device. Folding devices may include synchronization components that synchronize the movement of assemblies of the folding device. For instance, the synchronization components may include a synchronization slider that is mirror image cammed against the assemblies about rotational axes of the assemblies such that the synchronization slider translates along a direction parallel to the rotational axes as the assemblies are moved (e.g., as the folding device is opened and closed). With the mirror image camming, the synchronization slider may force the assemblies to maintain symmetrical/opposite angles as they are opened and closed. Such synchronization may advantageously improve structural integrity (e.g., by ensuring alignment of hinge assembly components) and user experience (e.g., a smooth, predictable opening and closing process).

Various components of the folding device may exert force to bias the folding device open. For instance, a foldable display of the folding device may, when the folding device is closed, exert a force pushing the assemblies away from the closed state (i.e., towards an open state). Such a force may cause the folding device to undesirably open (e.g., when not intentionally being opened by a user). As such, it may be desirable for folding devices to include a mechanism to counter the force and bias the assemblies into the closed state.

In accordance with one or more aspects of this disclosure, a folding device may include synchronization components that bias the assemblies into the closed state. For instance, a synchronization slider of the synchronization components may include one or more projections that interact with a latching track to provide a force to retain the folding device in the closed state. Such a force may be strong enough to prevent the foldable display from “popping” the folding device open, but weak enough to be easily overcome by a user attempting to open the folding device. In this way, synchronization components may bias the assemblies into the closed state.

An example folding device includes a hinge assembly; a first assembly rotatably connected to the hinge assembly about a first axis; a second assembly rotatably connected to the hinge assembly about a second axis; and a continuous display spanning the hinge assembly and connected to the first assembly and the second assembly, wherein the hinge assembly comprises: a synchronization slider configured to synchronize movement of the first assembly and the second assembly, wherein, as the first assembly and the second assembly rotate, the synchronization slider translates along a direction parallel to the first axis and the second axis, and wherein the synchronization slider includes one or more projections perpendicular to the direction; and a latching track disposed within the hinge assembly and configured to interface with the one or more projections of the synchronization slider to provide a force to retain the folding device in a closed state.

The details of one or more examples are set forth in the accompanying drawings and the description below. Other features, objects, and advantages of the disclosure will be apparent from the description and drawings, and from the claims.

### BRIEF DESCRIPTION OF DRAWINGS

FIG. 1 is a schematic diagram illustrating a cross section of a folding device 100 with a flexible display and a hinge assembly with a hold-closed force, in accordance with one or more aspects of this disclosure.

FIG. 2 is a schematic diagram illustrating an example folding device with a flexible display in a plurality of folded states, in accordance with one or more aspects of this disclosure.

FIGS. 3A and 3B are schematic diagrams illustrating components of a hinge assembly, in accordance with one or more aspects of this disclosure.

FIGS. 4A-4D are schematic diagrams illustrating an example hinge assembly with a hold-closed force, in accordance with one or more aspects of this disclosure.

FIGS. 5A-5E are schematic diagrams illustrating an example hinge assembly with a hold-closed force, in accordance with one or more aspects of this disclosure.

FIG. 6 is a schematic diagram illustrating another example of a hinge assembly with a hold-closed force, in accordance with one or more aspects of this disclosure.

### DETAILED DESCRIPTION

In general, this disclosure is directed to folding devices that include foldable continuous displays with a supported span. A folding device may include at least two assemblies (e.g., panels) and a mechanism configured to allow the assemblies to be moved into a collapsed state in which the device is considered closed and an expanded state in which the device is considered open. When the device is in the expanded state, a display may be visible and may cover at least a portion of an inner surface of all of the assemblies. As such, the device may be considered to be a continuous display (i.e., because it continues across or spans a boundary between the assemblies). By utilizing such a folding device, the device may include a display with a relatively large length and/or width (e.g., display area) without overly increasing a length and/or width of the device when in the collapsed state. In this way, the “pocketability” of large-screen portable devices may be improved.

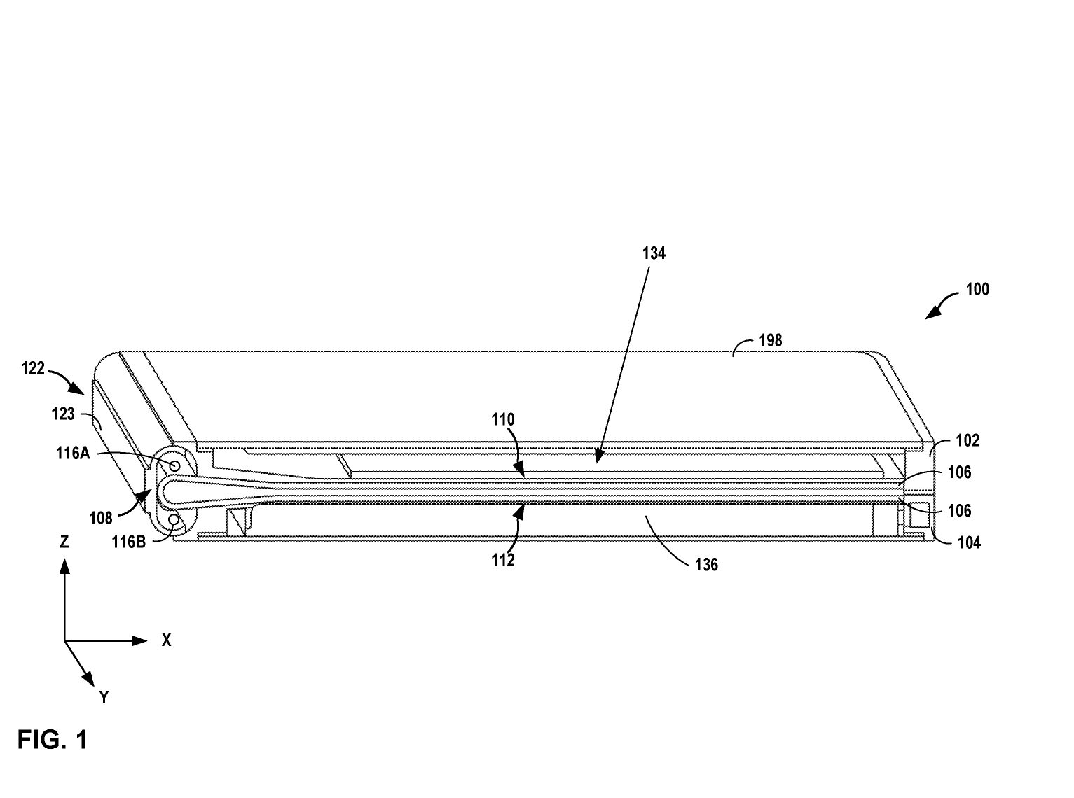

FIG. 1 is a schematic diagram illustrating a cross section of a folding device 100 with a flexible display and a hinge assembly with a hold-closed force, in accordance with one or more aspects of this disclosure. Examples of device 100 include foldable mobile computing devices such as foldable smart phones, foldable tablets, foldable e-readers, foldable gaming systems, or any other foldable portable device that includes a display.

As shown in FIG. 1, device 100 includes a first assembly 102, second assembly 104, continuous display 106, and hinge assembly 122. First assembly 102 may be rotatably connected to hinge assembly 122 about first axis 116A and second assembly 104 may be rotatably connected to hinge assembly 122 about second axis 116B. Each of first assembly 102 and second assembly 104 may include an inner surface and an outer surface. The outer surface of first assembly 102 may be visible when looking down at device 100 in the z-axis and the outer surface of second assembly 104 may be visible when looking up at device 100 in the z-axis. The inner surfaces of first assembly 102 and second assembly 104 may not be externally visible when device 100 is closed. While illustrated and described as including two assemblies, device 100 is not so limited. For instance, in some examples, device 100 may include three (or more) assemblies connected in series by two (or more) hinges.

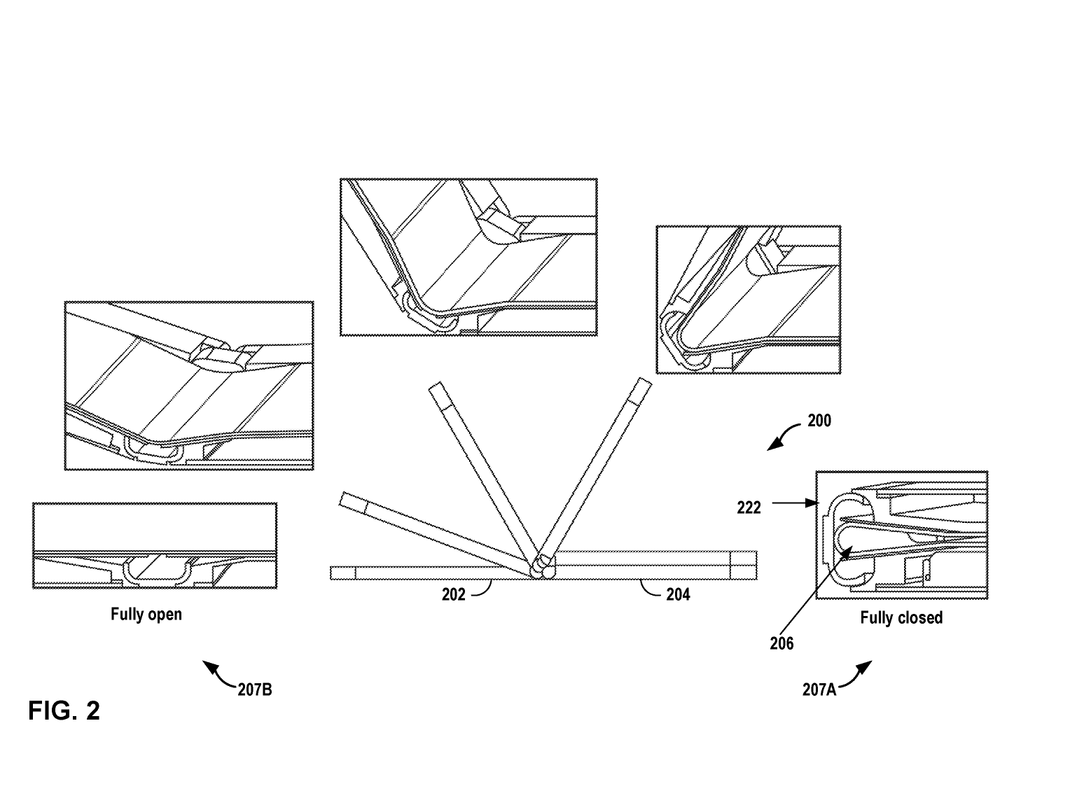

In operation, first assembly 102 and second assembly 104 may respectively rotate about axes 116A and 116B as device 100 is opened and closed. Device 100 is shown as fully closed in the example of FIG. 1. Other example states, including fully open and intervening positions between open and closed, are shown in FIG. 2.

Device 100 may include synchronization components that synchronize the movement of assemblies 102 and 104. For instance, the synchronization components may include a synchronization slider that is mirror image cammed against assemblies 102 and 104 about axes 116A and 116B such that the synchronization slider translates along a direction parallel to the rotational axes (e.g., a direction parallel to the Y axis) as assemblies 102 and 104 are moved (e.g., as the folding device is opened and closed). As discussed in further detail below, the synchronization slider may move within hinge assembly 122. With the mirror image camming, the synchronization slider may force assemblies 102 and 104 to maintain symmetrical/opposite angles as they are opened and closed. Such synchronization may advantageously improve structural integrity (e.g., by ensuring alignment of hinge assembly components) and user experience (e.g., a smooth, predictable opening and closing process).

As shown in FIG. 1, first assembly 102 may include main logic board 134 and second assembly 104 may include battery 136. This is merely one example arrangement of components amongst first assembly 102 and/or second assembly 104; other arrangements are possible. For instance, both first assembly 102 and second assembly 104 may include respective batteries.

Continuous display 106 may be capable of rendering data into images viewable by a user of device 100. For example, continuous display 106 may include a matrix of pixels that are individually controllable. Examples of continuous display 106 include, but are not limited to, liquid crystal displays (LCD), light emitting diode (LED) displays, organic light-emitting diode (OLED) displays, micro light-emitting diode (microLED) displays, or similar monochrome or color displays capable of outputting visible information to a user of device 100. Continuous display 106 may span hinge assembly 122 from first assembly 102 to second assembly 104.

In some examples, device 100 may include one or more displays in addition to continuous display 106. For instance, as shown in FIG. 1, device 100 may include a first additional display on the outer surface of first assembly 102 (e.g., display 198). In some examples, device 100 may further include a second additional display on the outer surface of second assembly 104.

One or more of continuous display 106, the first additional display, and/or the second additional display may be presence-sensitive displays. In some examples, a presence sensitive display may detect an object at and/or near a screen. As one example range, a presence-sensitive display may detect an object, such as a finger or stylus that is within 2 inches of the screen. The presence-sensitive display may determine a location (e.g., an (x,y) coordinate) of a screen at which the object was detected. In another example range, a presence-sensitive display may detect an object within six inches of the screen. Other ranges are also possible. The presence-sensitive display may determine the location of the screen selected by a user’s finger using capacitive, inductive, and/or optical recognition techniques. In some examples, presence sensitive display also provides output to a user using tactile, audio, or video stimuli.

As shown in the example of FIG. 1, continuous display 106 includes first rigid segment 110 attached to first assembly 102 (e.g., positioned on the inner surface of first assembly 102 and coplanar with the inner surface of first assembly 102), flexible segment 108, and second rigid segment 112 attached to second assembly 104 (e.g., positioned on the inner surface of second assembly 104 and coplanar with the inner surface of first assembly 102).

Flexible segment 108 may connect the rigid segments of one side of device 100 to the rigid segments of the other side of device 100. For instance, as shown in FIG. 1, flexible segment 108 may connect rigid segment 110 to rigid segment 112. Flexible segment 108 may be configured to fold at least 180 degrees (e.g., to facilitate closure of device 100). Flexible segment 108 may have a cross section (e.g., in the X-Y plane) in the folded state that enables bending. As shown in FIG. 1, flexible segment 108 may generally have a tear-drop cross section, though other cross sections are contemplated.

Device 100 may include one or more supporting plates (e.g., backer plates) configured to render segments of continuous display 106 flexible or rigid. The supporting plates may be positioned between emissive elements of continuous display 106 (e.g., OLEDs) and the inner surfaces of first assembly 102 and second assembly 104.

In some examples, device 100 may include respective supporting plates for segments of continuous display 106. For instance, the one or more supporting plates may include a first supporting plate attached to first rigid segment 110, a second supporting plate attached to second rigid segment 112, and a third supporting plate attached to foldable segment 108.

In some examples, the one or more supporting plates may include a respective supporting plate for each of first assembly 102 and second assembly 104 that support segments of continuous display 106 on the respective assembly. In some examples, the one or more supporting plates may include a single supporting plate that is attached to segments of continuous display 106 on both first assembly 102 and second assembly 104. For instance, the one or more supporting plates may include a single supporting plate attached to primary flexible segment 108 and all rigid segments (e.g., first rigid segment 110, second rigid segment 112). The single supporting plate may be configured to permit bending between the segments. To permit bending between segments, a supporting plate may be etched and/or perforated at a boundary between adjacent segments.

Hinge assembly 122 may include various components that facilitate the movement of assemblies 102 and 104 such that device 100 may open and close. Further details of components of hinge assembly 122 are discussed below. As shown in FIG. 1, hinge assembly 122 may include hinge cover 123 positioned over an outer surface of hinge assembly 122. Hinge cover 123 may define an outer surface of hinge assembly 122. Hinge cover 123 may act as both an aesthetic cover to hide other components of hinge assembly 122 and an environmental barrier to shield the components of hinge assembly 122 from dust etc.

Components of device 100 may exert a force that pushes assemblies 102 and 104 away from the closed state (i.e., towards an open state). For instance, one or both of the supporting plates and continuous display 106 may, at least when device 100 is in the fully closed state, exert such a force (e.g., due to being folded). Such a force may cause device 100 to undesirably open (e.g., when not intentionally being opened by a user). As such, it may be for desirable device 100 to include a mechanism to counter the force and bias the assemblies into the closed state.

In accordance with one or more aspects of this disclosure, the synchronization components of device 100 may be configured to provide the force and bias the assemblies into the closed state. For instance, the synchronization slider of the synchronization components may include one or more projections that interact with a latching track to provide a force to retain device 100 in the closed state. Such a force may be strong enough to prevent continuous display 106 from “popping” the folding device open, but weak enough to be easily overcome by a user attempting to open device 100. In this way, synchronization components may bias assemblies 102 and 104 into the closed state.

FIG. 2 is a schematic diagram illustrating a folding device 200 with a flexible continuous display 206 in a plurality of folded states, in accordance with one or more aspects of this disclosure. Device 200 may be an example of device 100 shown in FIG. 1. Similarly, first assembly 202 and second assembly 204 of FIG. 2 may be examples of first assembly 102 and second assembly 104 of FIG. 1. As shown in FIG. 2, a portion of display 206 resides within a hinge assembly 222 while device 200 is closed, e.g., a collapsed state 207A. As further shown in FIG. 2, when folding device 200 is fully open, e.g., an expanded state 207B, an inner surface of a first assembly 202 is coplanar with an inner surface of a second assembly 204.

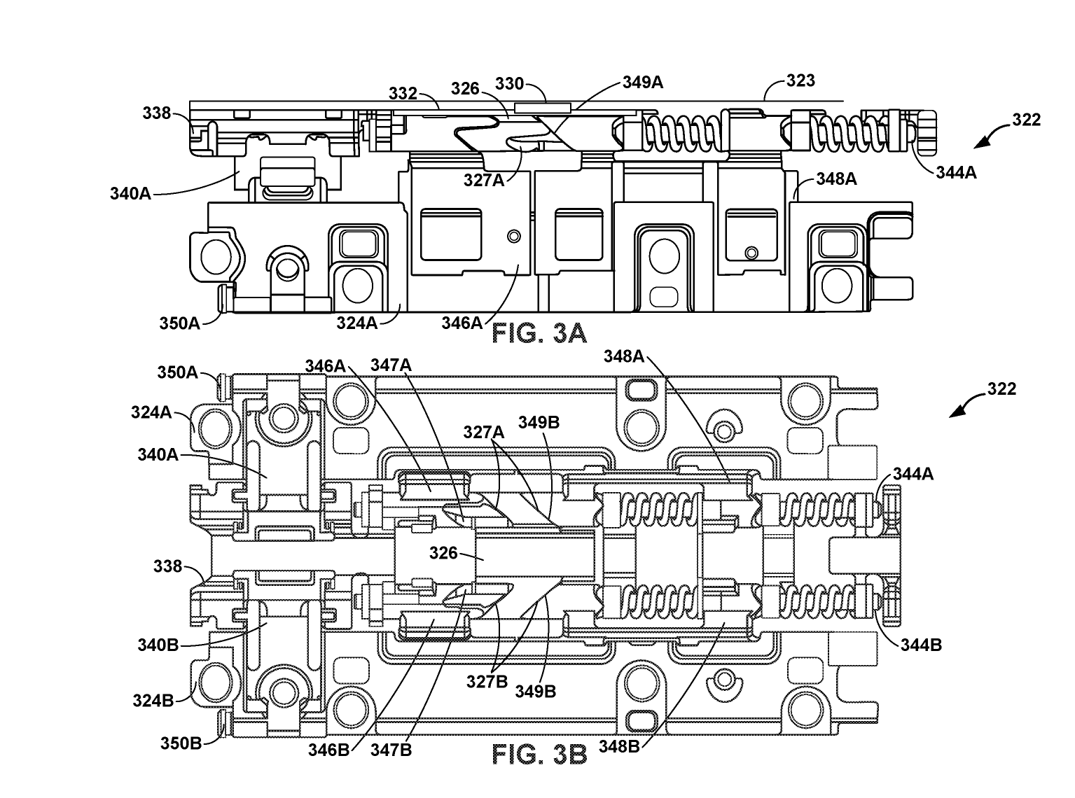

FIGS. 3A and 3B are schematic diagrams illustrating components of a hinge assembly 322, in accordance with one or more aspects of this disclosure. FIG. 3A illustrates hinge assembly 322 in a fully closed state while FIG. 3B illustrates hinge assembly 322 in a fully open state. Hinge assembly 322 may be an example of hinge assembly 122 shown in FIG. 1. Similarly, hinge cover 323 may be an example of hinge cover 123 of FIG. 1. In some instances, and for example purposes only, FIG. 3 is discussed with respect to first assembly 102 and second assembly 104 of FIG. 1. While only a single hinge assembly 322 is illustrated, in some examples, a folding device may include multiple instances of hinge assembly 322 along its spine.

As shown in FIGS. 3A and 3B, hinge assembly 322 may include hinge brackets 324A and 324B (collectively, “hinge brackets 324”), synchronization slider 326, barrel 338, scoops 340A and 340B (collectively, “scoops 340”), shafts 344A and 344B (collectively, “shafts 344”), synchronization arms 346A and 346B (collectively, “synchronization arms 346”), hinge arms 348A and 348B (collectively, “hinge arms 348”), and pins 350A and 350B (collectively, “pins 350”).

Barrel 338 may include curved passages through which medial portions of scoops 340 may move (e.g., to facilitate opening and closing rotational movements). Lateral portions of scoops 340 may be coupled to hinge brackets 324, such as via pins 350. Hinge brackets 324 may be attached to assemblies (e.g., first assembly 102 and second assembly 104 of FIG. 1) and may serve to couple said assemblies to hinge assembly 322.

Synchronization arms 346, synchronization slider 326, hinge arms 348 are distributed axially along shafts 344. Shafts 344 each define a respective axis, which may or may not be examples of axes 116A and 116B of FIG. 1. Synchronization arms 346 and torque arms 348 may both include features that rotationally lock them to hinge brackets 324. For instance, as hinge bracket 324B rotates (e.g., as second assembly 104 rotates), said features cause synchronization arm 346B and torque arm 348B to rotate about shaft 344B.

Synchronization slider 326, synchronization arms 346, and hinge arms 348 may collectively synchronize movement of hinge brackets 324 (and associated assemblies coupled to hinge brackets 324, such as first assembly 102 and second assembly 104). In some examples, to synchronize the movement, synchronization slider 326 may be mirror image cammed against the assemblies. For instance, synchronization slider 326 may include cam surfaces 327A and 327B (collectively, “cam surfaces 327”), synchronization arms 346 may include cam surfaces 347A and 347B (collectively, “cam surfaces 347”), and hinge arms 348 may include cam surfaces 349A and 349B (collectively, “cam surfaces 349”). In operation, synchronization arms 346 and hinge arms 348 may be rotationally locked to hinge brackets 324 and may therefore rotate about shafts 344 as hinge brackets 324 rotate. The rotation of synchronization arms 346 and hinge arms 348 may cause cam surfaces 347 and 349 respectively of synchronization arms 346 and hinge arms 348 to interact with cam surfaces 327 of synchronization slider 326. Due to the shape of cam surfaces 327, 347, and 349 (e.g., being mirror images of each other and having curved ramps), the rotation of synchronization arms 346 and hinge arms 348 may cause linear movement of synchronization slider 326 along shafts 344. As such, where shafts 344 respectively define a first axis and a second axis, synchronization slider 326 may translate along a direction parallel to the first axis and the second axis. As can be seen in FIG. 3A, where hinge assembly 322 is closed and synchronization slider 326 is more towards the left of the page, and in FIG. 3B where hinge assembly 322 is open and synchronization slider 326 is more towards the right of the page. As hinge assembly 322 is moved from fully opened to fully closed, synchronization slider 326 may move a distance D (e.g., a translation distance) along shafts 344.

With synchronization slider 326 having symmetrical but mirror imaged interaction with hinge brackets 324 (e.g., via cam surfaces 327, 347, and 349), such action of synchronization slider 326 may result in synchronization of movement of hinge brackets 324 (and associated assemblies coupled to hinge brackets 324, such as first assembly 102 and second assembly 104).

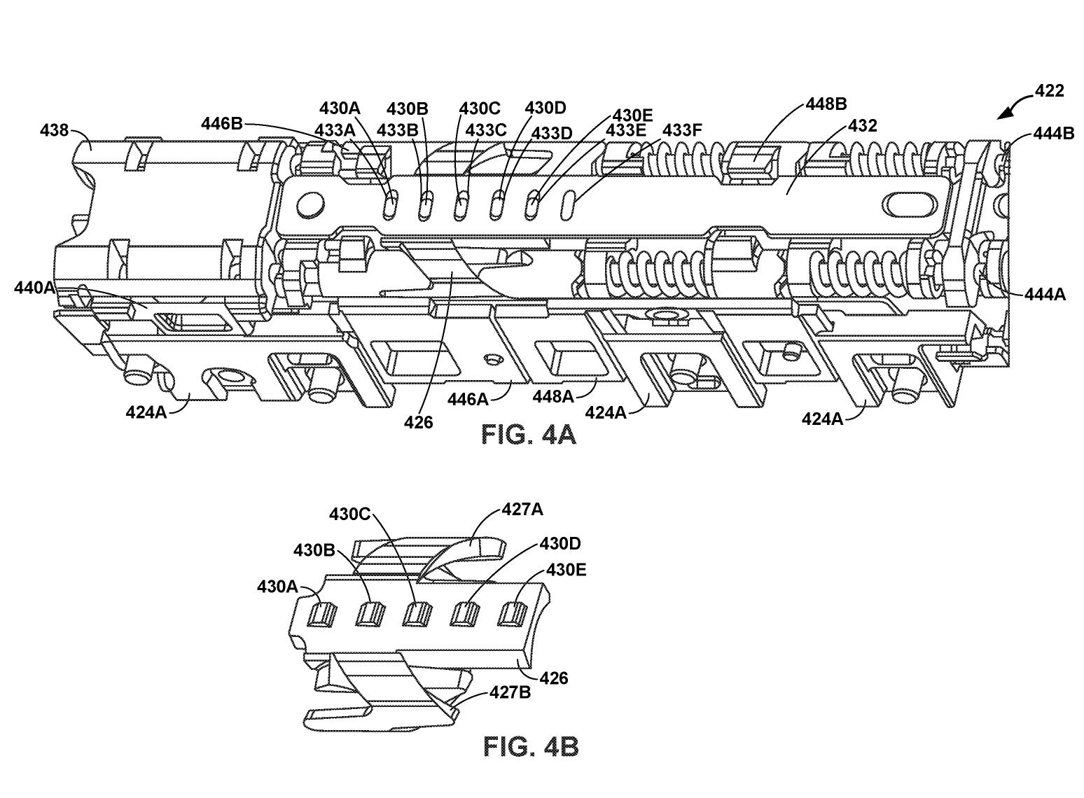

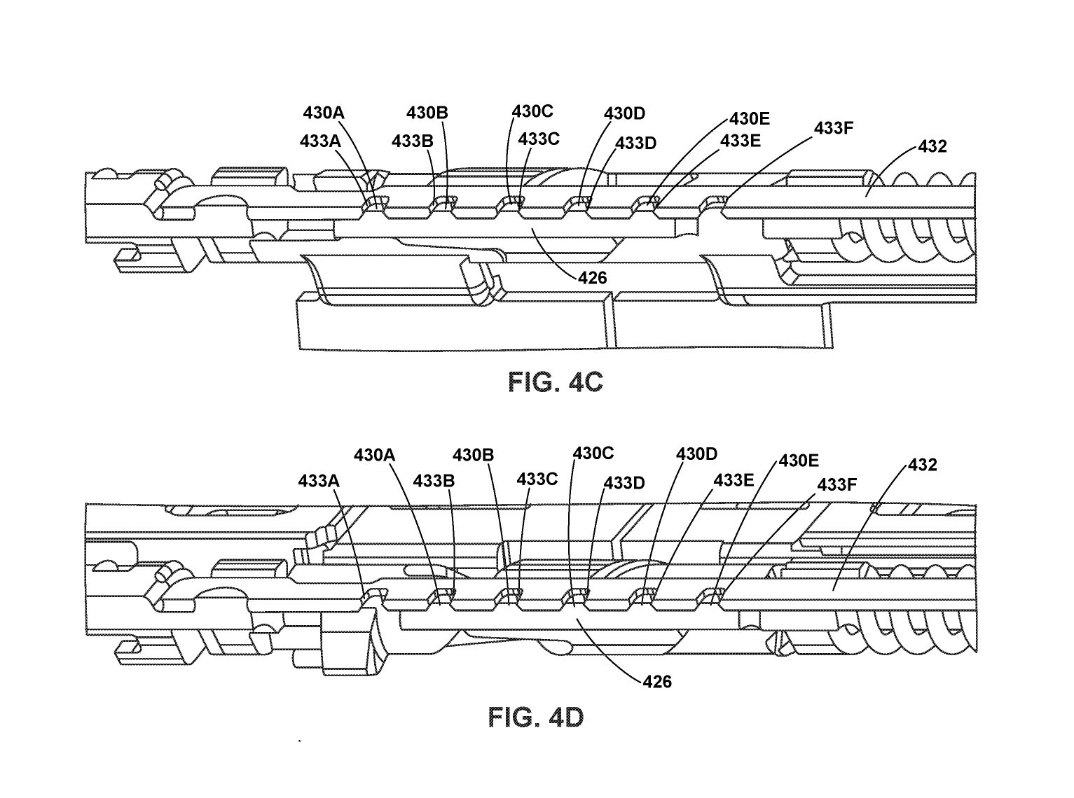

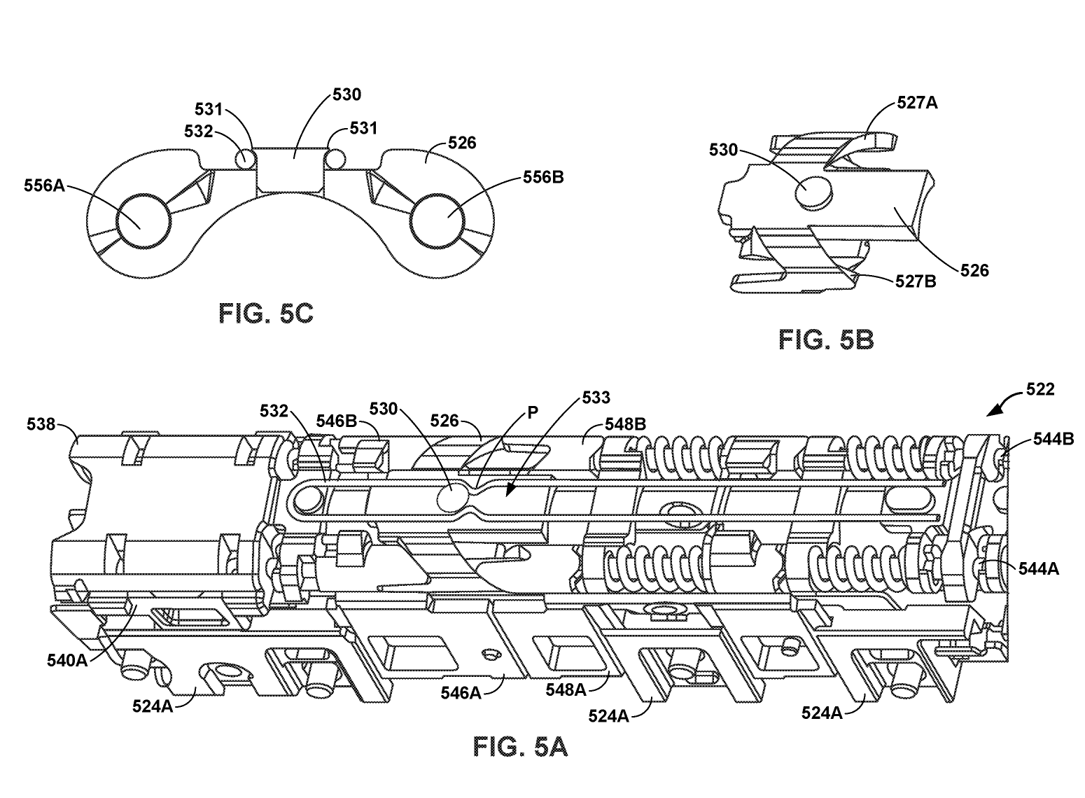

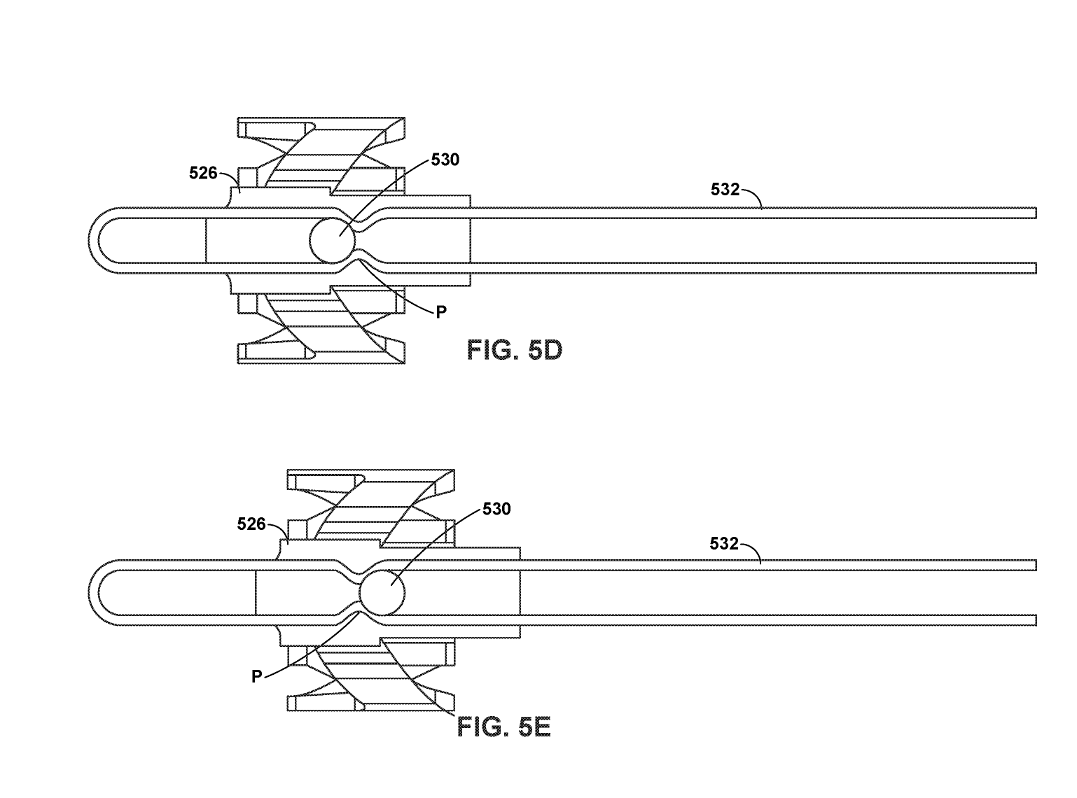

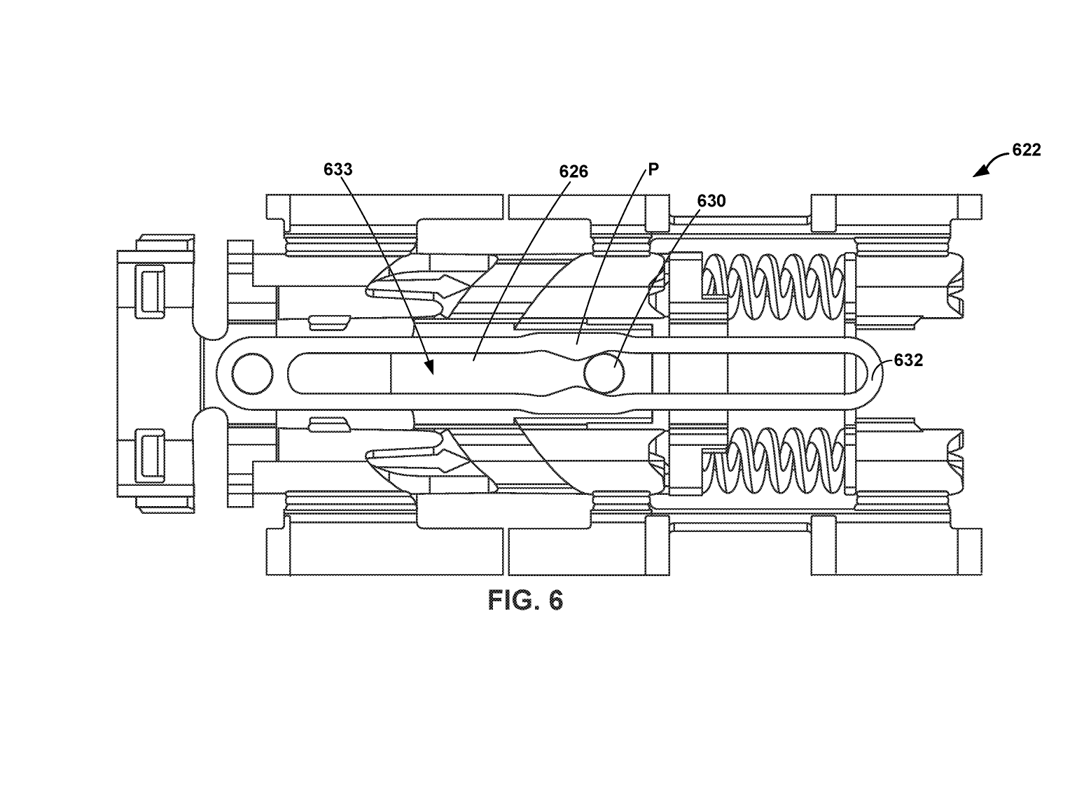

As discussed above and in accordance with one or more aspects of this disclosure, synchronization slider 326 may include one or more projections 330 that interact with latching track 332 to provide a force to retain hinge assembly 322 in the closed state. Projections 330 may take a variety of forms. As one example, projections 330 may include a plurality of latching teeth. Further details of examples of projections 330 with latching teeth are discussed below with reference to FIGS. 4A-4D. As another example, projections 330 may include a single projection. Further details of examples of projections 330 with a single projection are discussed below with reference to FIGS. 5A-5E and FIG. 6. Projections 330 may be disposed on a surface of synchronization slider 326 proximate to an outer surface of hinge assembly 322 (e.g., a spine of hinge assembly 322).

As shown in FIG. 3A, latching track 332 may be positioned between synchronization slider 326 and hinge cover 323. Such positioning of latching track 332 may be desirable in that the space between synchronization slider 326 and hinge cover 323 may otherwise not be occupied such that latching track 332/projections 330 may be included in hinge assembly 322 without increasing a size of hinge assembly 322.

FIGS. 4A-4D are schematic diagrams illustrating an example hinge assembly with a hold-closed force, in accordance with one or more aspects of this disclosure. FIG. 4A illustrates hinge assembly 422 in a fully closed state, FIG. 4B illustrates a view of synchronization slider 426, FIG. 4C illustrates a cross-section view of components of hinge assembly 422 in the closed state, and FIG. 4D illustrates a cross-section view of components of hinge assembly 422 in an open state. Hinge assembly 422 may be an example of hinge assembly 122 shown in FIG. 1 or hinge assembly 322 of FIGS. 3A and 3B. In some instances, and for example purposes only, FIG. 4 is discussed with respect to first assembly 102 and second assembly 104 of FIG. 1.

Elements with like suffix reference numbers of FIGS. 4A-4D may be examples of similar elements of FIGS. 3A and 3B. For instance, hinge bracket 424A, synchronization slider 426, barrel 438, scoop 440A, synchronization arms 446A and 446B (collectively, “synchronization arms 446”), hinge arms 448A and 448B (collectively, “hinge arms 448”), shafts 444A and 444B (collectively, “shafts 444”), cam surfaces 427A and 427B (collectively, “cam surfaces 427”), projections 430A-430E (collectively, “projections 430”), and latching track 432 of FIGS. 4A-4D may respectively be examples of hinge bracket 324A, synchronization slider 326, barrel 338, scoop 340A, synchronization arms 346, hinge arms 348, shafts 344, cam surfaces 327, projections 330, and latching track 332 of FIGS. 3A and 3B.

As shown in FIGS. 4A-4D, projections 430 may include a plurality of latching teeth disposed along a direction parallel to shafts 444. The latching teeth may include a raised portion with a ramp or sloped position on either side along the direction. Latching track 432 may include features that interface with projections 430. For instance, latching track 432 may define holes 433A-433F that interact with projections 430. Holes 433 may be similarly disposed along the direction and may be configured to receive the latching teeth. In some examples, latching track 432 may be a latching plate in which holes 433 are formed (e.g., latching track 432 may be formed of sheet metal and holes 433 may be stamped into the sheet metal).

In some examples, latching track 432 may be attached to hinge assembly 422 at its ends. By attaching latching track 432 at its ends, a portion of latching track that includes holes 433 may be able to flex “up” (e.g., away from synchronization slider 426) as synchronization slider 426 moves. Such flexing may enable projections 430 to more easily transit between holes 433.

As can be seen in FIGS. 4A-4D, a quantity of holes in holes 433 may be greater than a quantity of latching teeth in projections 430. In some examples, where the quantity of latching teeth in projections 430 is N, the quantity of holes in holes 433 may be N+1.

As can also be seen in FIGS. 4A-4D, a spacing between adjacent holes of holes 433 may be selected based on a translation distance of synchronization slider 426 (e.g., the total distance traveled by synchronization slider 426 along the direction as hinge assembly 422 is moved between fully open and fully closed). For instance, if the translation distance is D, the distance between adjacent holes of holes 433 may be selected as D, D/2, D/4, etc. Where the distance between adjacent holes of holes 433 is D, such distance may be considered to be substantially equal to the translation distance. The spacing between adjacent latching teeth of projections 430 may be similarly selected.

In operation, when hinge assembly 422 is closed, projections 430 may occupy a first set of holes 433. For instance, when hinge assembly 422 is closed, projections 430A-430E may respectively occupy holes 433A-433E. As hinge assembly 422 is opened, synchronization slider 426 may slide along the direction (e.g., move to the right in the page of FIG. 4A). Such movement may cause projections 430 to depart from the first set of holes. As hinge assembly 422 reaches an open position, projections 430 may occupy a second set of holes that is, at least in part, different than the first set of holes. For instance, when hinge assembly 422 is open, projections 430A-430D may respectively occupy holes 433B-433F.

While projections 430 may be movable between holes 433, such movement may require force. For instance, absent outside forces, projections 430 may tend to stay within holes of holes 433 currently occupied. Such action may provide a hold closed force. For instance, the requirement of force for projections 430 to move between holes may exert a force that biases against movement of synchronization slider 426. In this way, aspects of this disclosure may provide a hold-closed force to hinge assembly 422.

FIGS. 5A-5E are schematic diagrams illustrating an example hinge assembly with a hold-closed force, in accordance with one or more aspects of this disclosure. FIG. 5A illustrates hinge assembly 522 in a fully closed state, FIG. 5B illustrates a view of synchronization slider 526, FIG. 5C illustrates a cross-sectional view of synchronization slider 526 and latching track 532, FIG. 5D illustrates a view of components of hinge assembly 522 in a closed state, and FIG. 5E illustrates a view of components of hinge assembly 522 in an open state. Hinge assembly 522 may be an example of hinge assembly 122 shown in FIG. 1 or hinge assembly 322 of FIGS. 3A and 3B. In some instances, and for example purposes only, FIG. 5 is discussed with respect to first assembly 102 and second assembly 104 of FIG. 1.

Elements with like suffix reference numbers of FIGS. 5A-5E may be examples of similar elements of FIGS. 3A and 3B. For instance, hinge bracket 524A, synchronization slider 526, barrel 538, scoop 540A, synchronization arms 546A and 546B (collectively, “synchronization arms 546”), hinge arms 548A and 548B (collectively, “hinge arms 548”), shafts 544A and 544B (collectively, “shafts 544”), cam surfaces 527A and 527B (collectively, “cam surfaces 527”), projection 530, latching track 532 of FIGS. 5A-5E may respectively be examples of hinge bracket 324A, synchronization slider 326, barrel 338, scoop 340A, synchronization arms 346A, hinge arms 348, shafts 344, cam surfaces 327, projections 330, and latching track 332 of FIGS. 3A and 3B.

As shown in FIGS. 5A-5E, projections 530 may include a single projection 530 that moves within channel 533 defined by latching track 532. The single projection 530 may include features that retain projection 530 within channel 533, such as flared portion 531. A width of channel 533 may be constrained at point P such that moving projection 530 through point P takes more force than moving projection 530 through non-constrained portions of channel 533 (e.g., portions of channel 533 other than point P). The position of constrained point P on channel 533 may be selected such that synchronization slider 526 is held in the closed position (e.g., the position of FIG. 5A).

In some examples, latching track 532 may be open on at least one end (e.g., the right end in FIG. 5A). By having latching track 532 be open on one end, latching track 532 may be able to more easily flex away from projection 530 as projection 530 passes through constricted point P.

In operation, when hinge assembly 522 is closed, synchronization slider 526 (and thereby projection 530) may be in a closed position. When synchronization slider 526 is in the closed position, projection 530 may rest against constrained point P of channel 533. The constraining of channel 533 at point P may result in projection 530/synchronization slider 526 being held in the closed position. However, as force is applied to open hinge assembly 522, synchronization slider 526 may begin moving along shafts 544 (e.g., to the right in FIG. 5A). Synchronization slider 526 may define openings 556A and 556B, through which shafts 544 travel. Such movement of synchronization slider 526 may cause projection 530 to transit constrained point P, which may require extra force to cause latching track 532 to flex away and allow projection 530 to pass point P. In this way, aspects of this disclosure may provide a hold-closed force to hinge assembly 522.

In the example of FIG. 5A-5E, latching track 532 may be formed of a shaped wire. For instance, latching track 532 may be an aluminum, steel, or other metal wire having a shape that defines channel 533 and point P.

FIG. 6 is a schematic diagram illustrating another example of a hinge assembly with a hold-closed force, in accordance with one or more aspects of this disclosure. The example of FIG. 6 illustrates hinge assembly 622 in an open state. Hinge assembly 622 of FIG. 6 may be an example of hinge assembly 522 of FIGS. 5A-5E. Similarly, synchronization slider 626, projection 630, and latching track 632 of FIG. 6 may respectively be examples of synchronization slider 526, projection 530, and latching track 532 of FIGS. 5A-5E. However, in the example of FIG. 6, latching track 632 may be a plate (e.g., as opposed to a wire). For instance, latching track 632 may be a stamped piece of sheet metal that defines channel 633 and point P.

The following numbered examples may illustrate one or more aspects of this disclosure:

Example 1. A folding device comprising: a hinge assembly; a first assembly rotatably connected to the hinge assembly about a first axis; a second assembly rotatably connected to the hinge assembly about a second axis; and a continuous display spanning the hinge assembly and connected to the first assembly and the second assembly, wherein the hinge assembly comprises: a synchronization slider configured to synchronize movement of the first assembly and the second assembly, wherein, as the first assembly and the second assembly rotate, the synchronization slider translates along a direction parallel to the first axis and the second axis, and wherein the synchronization slider includes one or more projections perpendicular to the direction; and a latching track disposed within the hinge assembly and configured to interface with the one or more projections of the synchronization slider to provide a force to retain the folding device in a closed state.

Example 2. The folding device of example 1, wherein the synchronization slider is mirror image cammed against the first assembly and the second assembly to translate along the direction.

Example 3. The folding device of example 1, wherein the one or more projections are disposed on a surface of the synchronization slider proximate to an outer surface of the hinge assembly.

Example 4. The folding device of example 1, wherein the one or more projections comprise a plurality of latching teeth disposed along the direction, and wherein the latching track comprises a plurality of holes disposed along the direction and configured to receive the plurality of latching teeth.

Example 5. The folding device of example 4, wherein a quantity of holes in the plurality of holes is greater than a quantity of latching teeth in the plurality of latching teeth.

Example 6. The folding device of example 4, wherein a distance between adjacent holes of the plurality of holes is substantially equal to a translation distance of the synchronization slider as the folding device moves between the closed state and a fully open state.

Example 7. The folding device of example 4, wherein the latching track comprises a latching plate in which the plurality of holes are formed.

Example 8. The folding device of example 1, wherein the latching track defines a channel, wherein the one or more projections comprise a single projection that moves within the channel as the synchronization slider translates along the direction, wherein a width of the channel is constricted at a point, and wherein moving the single projection through the constricted point takes more force than moving the single projection through non-constricted points of the channel.

Example 9. The folding device of example 8, wherein the latching track flexes away from the single projection as the single projection moves through the constricted point.

Example 10. The folding device of example 8, wherein the single projection includes a flared portion configured to retain the single projection within the channel.

Example 11. The folding device of example 8, wherein the latching track comprises a shaped wire.

Example 12. The folding device of example 8, wherein the latching track comprises a plate.

Example 13. The folding device of example 1, further comprising a hinge cover positioned over the outer surface of the hinge assembly, wherein the latching track is positioned between the synchronization slider and the hinge cover.

Various aspects have been described in this disclosure. These and other aspects are within the scope of the following claims.

1. A folding device comprising:
a hinge assembly;
a first assembly rotatably connected to the hinge assembly about a first axis;
a second assembly rotatably connected to the hinge assembly about a second axis; and
a continuous display spanning the hinge assembly and connected to the first assembly and the second assembly, wherein the hinge assembly comprises:
a synchronization slider configured to synchronize movement of the first assembly and the second assembly, wherein, as the first assembly and the second assembly rotate, the synchronization slider translates along a direction parallel to the first axis and the second axis, and wherein the synchronization slider includes one or more projections perpendicular to the direction; and
a latching track disposed within the hinge assembly and configured to interface with the one or more projections of the synchronization slider to provide a force to retain the folding device in a closed state.

2. The folding device of claim 1, wherein the synchronization slider is mirror image cammed against the first assembly and the second assembly to translate along the direction.

3. The folding device of claim 1, wherein the one or more projections are disposed on a surface of the synchronization slider proximate to an outer surface of the hinge assembly.

4. The folding device of claim 1, wherein the one or more projections comprise a plurality of latching teeth disposed along the direction, and wherein the latching track comprises a plurality of holes disposed along the direction and configured to receive the plurality of latching teeth.

5. The folding device of claim 4, wherein a quantity of holes in the plurality of holes is greater than a quantity of latching teeth in the plurality of latching teeth.

6. The folding device of claim 4, wherein a distance between adjacent holes of the plurality of holes is substantially equal to a translation distance of the synchronization slider as the folding device moves between the closed state and a fully open state.

7. The folding device of claim 4, wherein the latching track comprises a latching plate in which the plurality of holes are formed.

8. The folding device of claim 1, wherein the latching track defines a channel, wherein the one or more projections comprise a single projection that moves within the channel as the synchronization slider translates along the direction, wherein a width of the channel is constricted at a point, and wherein moving the single projection through the constricted point takes more force than moving the single projection through non-constricted points of the channel.

9. The folding device of claim 8, wherein the latching track flexes away from the single projection as the single projection moves through the constricted point.

10. The folding device of claim 8, wherein the single projection includes a flared portion configured to retain the single projection within the channel.

11. The folding device of claim 8, wherein the latching track comprises a shaped wire.

12. The folding device of claim 8, wherein the latching track comprises a plate.

13. The folding device of claim 1, further comprising a hinge cover positioned over an outer surface of the hinge assembly, wherein the latching track is positioned between the synchronization slider and the hinge cover.
